(19) United States
(12) Patent Application Publication
(10) Pub. No.: US 2026/0013425 A1
(43) Pub. Date: Jan. 15, 2026

(54) LINE TRIMMER WITH SPOOL MOTOR

(71) Applicant: THE TORO COMPANY, Bloomington, MN (US)

(72) Inventors: Chris A. Wadzinski, Inver Grove Heights, MN (US); Landon M. Schulteis, Prior Lake, MN (US); Adam J. Bower, Lauderdale, MN (US)

(21) Appl. No.: 19/266,906

(22) Filed: Jul. 11, 2025

Related U.S. Application Data
(60) Provisional application No. 63/670,224, filed on Jul. 12, 2024.

(51) Int. Cl. A01D 34/416; A01D 34/78

(52) U.S. Cl. CPC A01D 34/4161; A01D 34/78

(57) ABSTRACT

A line trimmer includes a trimming head and a spool is contained within the trimming head. The spool is selectively connected to the trimming head such that the trimming head and the spool rotate together when the line trimmer is in an operating mode. The spool is configured to receive a length of cutting line such that an end of the cutting line extends from the head and cut vegetation as the trimming head rotates. A first electric motor is contained within the housing and operatively coupled to rotate the trimming head along with the spool when the trimmer is in the operating mode. A second electric motor is contained within the housing and operatively coupled to rotate the spool independently from the trimming head, e.g., for winding and/or unwinding of the cutting line.

### RELATED PATENT DOCUMENTS

This application claims the benefit of U.S. Provisional Application No. 63/670,224, filed on Jul. 12, 2024, which is incorporated herein by reference in its entirety.

### SUMMARY

The present disclosure is directed to a line trimmer with a spool motor. In one embodiment, line trimmer includes a trimming head associated with a housing. A spool is contained within the trimming head. The spool is selectively connected to the trimming head and is configured to receive a length of cutting line such that one or more ends of the cutting line extend from the head and cut vegetation as the trimming head rotates. A first electric motor is contained within the housing and operatively coupled to the trimming head. The first electric motor is configured to rotate the trimming head, along with the spool, when the trimmer is in an operating mode. A second electric motor is contained within the housing and operatively coupled to the spool. The second electric motor configured to rotate the spool independently from the trimming head.

In another embodiment, method of operating a line trimmer involves selecting an operating mode via a first switch to activate a first electric motor operatively coupled to a trimming head. A spool is contained within and selectively connected to the trimming head such that the trimming head and the spool rotate when the line trimmer in the operating mode to cut vegetation via a cutting line that extends from the trimming head. The spool is configured to receive a length of the cutting line. A loading mode is selected via one or more second switches that activate a second electric motor different from the first motor that causes the spool to rotate independently of the trimming head in a first direction to retract or load the cutting line onto the spool. In another embodiment, instead of or in addition to the loading mode, a feeding mode is selected via the second switches to activate the second electric motor and cause the spool to rotate independently of the trimming head in a second direction to extend the cutting line from the spool.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures. The drawings are not necessarily to scale.

FIG. 1 is a perspective view of a line trimmer according to an example embodiment;

FIG. 2 is a block diagram of a line trimmer according to an example embodiment;

FIGS. 3 and 4 are a cutaway and perspective views of a motor assembly according to an example embodiment;

FIGS. 5 and 6 are a cutaway and perspective views of a motor assembly according to another example embodiment;

FIGS. 7 and 8 are cutaway and perspective views of a motor assembly according to another example embodiment;

FIGS. 9-11 are schematic diagrams illustrating control circuits according to an example embodiment;

FIG. 12 is a graph showing the operation of a pulsing relay used in the circuits of FIGS. 9-11;

FIG. 13 is a flowchart showing a method according to an example embodiment;

FIG. 14 is a state machine diagram depicting operation of a line trimmer according to an example embodiment; and

FIG. 15 is a block diagram of a controller system according to an example embodiment.

### DETAILED DESCRIPTION

In the following detailed description of illustrative embodiments, reference is made to the accompanying figures of the drawing which form a part hereof. It is to be understood that other equivalent embodiments, which may not be described and/or illustrated herein, are also contemplated.

The present disclosure relates generally to hand-held trimmers for cutting plants. While these devices may incorporate a variety of cutting elements, a popular option is referred to string trimmers or line trimmers. These trimmers utilize a filament line or string as the cutting member, which is referred to herein as a cutting line.

String trimmers are available with a variety of power sources ranging from internal combustion engines to electric motors, the latter being corded (e.g., running off of AC power mains) or uncorded (e.g., battery-powered). Electric options are increasingly popular due to, among other things, low noise, zero-emissions, ease of maintenance, ease of operation, and relative low cost (at least for corded versions).

Electric string trimmers generally include a cutting unit assembly that houses an electric motor. Coupled to the electric motor is a rotatable trimming/cutting head having a cutting line coiled around a spool within the head. A portion of the cutting line protrudes from one or more sides the trimming head. During operation, the trimming head rotates and the resulting centrifugal force stiffens the cutting line sufficiently to sever ground-growing vegetation such as grass, weeds, etc.

The end of the cutting line will eventually wear over time, thus needing more line to be extended from the spool to maintain the desired cutting circle. This is often achieved by bumping the head on the ground or some other surface, which causes the spool to unwind slightly (e.g., via a ratchet mechanism), allowing more line to feed out. If too much line is fed out, then the trimmer may include a blade at an edge of a shroud, for example, that will cut off any excess line when the head is rotated at speed.

When most of the line has been fed out from the spool, the operator will have to replace the line. Replacing the line sometimes involves disassembling part of the head, and manually winding new line onto the spool or replacing the old spool with a pre-wound spool. This process can be time-consuming, and is prone to operator error, e.g., winding the line in the wrong direction, tangles being created around the spool, etc. Therefore, an automatic means for winding the line around the spool is a desirable feature.

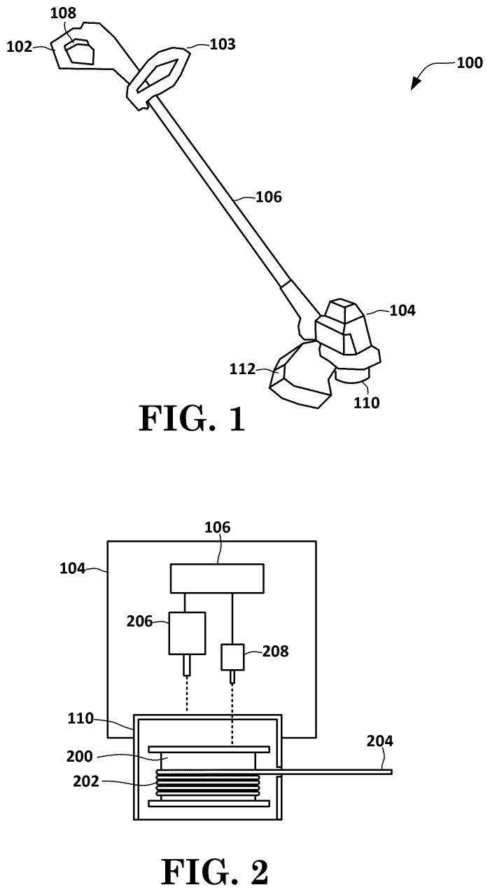

In embodiments described herein, a line trimmer or string trimmer includes two motors that perform separate operations of rotating the trimming head and winding/unwinding cutting line from the spool. In FIG. 1, a perspective view shows components of a line trimmer 100 according to an example embodiment. The line trimmer includes handles 102, 103, a housing 104, and a shaft 106 connecting the handles 102, 103 to the housing 104. An activation trigger 108 is available on a grip of the handle 102. The illustrated example is typical of a corded trimmer, in which a power cable (not shown) extends proximate handle 102. For battery powered trimmers, a battery would generally be located on a distal end of the shaft 106 with a differently shaped handle.

A trimming head 110 is associated with the housing 104, e.g., mounted to the housing 104 and extending from underneath the housing 104. The trimming head 110 rotates a trimming line (not shown) to create a cutting circle for cutting plant matter and the like. A shroud or guard 112 covers part of cutting circle to prevent debris from being thrown towards the operator. Additional features of the housing 104 and trimming head 110 are shown schematically in FIG. 2.

As seen in FIG. 2, a spool 200 is contained within the trimming head 110. The spool 200 is selectively connected to the trimming head 110 such that the trimming head 110 and spool 200 rotate together when the line trimmer 100 is configured in an operating mode, also referred to herein as a work mode, a cutting mode, or the like. The spool 200 is configured to receive a length of cutting line 202 such that one or more ends 204 of the cutting line 202 extend from the trimming head 110 and cut vegetation as the trimming head 110 rotates. Note that this embodiment shows one length of cutting line 202 coiled around the spool 200. Other embodiments have two lengths with two ends extending from opposite sides of the trimming head 110.

A first electric motor 206 is contained within the housing 104 and is operatively coupled to the trimming head 110. The first electric motor 206 is configured to rotate the trimming head 110, along with the spool 200, when the trimmer is in the operating mode. A second electric motor 208 is contained within the housing 104 and is operatively coupled to the spool 200 The second electric motor 208 is configured to rotate the spool 200 independently from the trimming head 110. In one scenario, the second electric motor 208 rotates the spool 200 only when the first electric motor 206 and trimming head 110 are stationary. In other scenarios, the second electric motor 208 may rotate along with the trimming head 110, and can induce a rotation into the spool 200 while it is rotating. This latter arrangement can be used to extend or retract the cutting line 202 in the operating mode.

The actuation of the second electric motor 208 without actuation of the first electric motor 206 permits powered winding of cutting line 202 onto the spool. This also permits powered unwinding of the cutting line 202, e.g., to extend the line after it has become worn from use. In such an arrangement, a rotational direction of the second electric motor 208 is selectable between a first direction configured to extend the cutting line 202 out of the trimming head 110 and a second direction configured to retract the cutting line 202 into the trimming head 110.

Due to the high duty cycle of the first electric motor 206, it may be a brushless DC motor with a high torque capability with a maximum speed of around 3000 to 6000 RPM. The second motor 208 will have a lower duty cycle as well as a lower speed, e.g., less than 10% of the first motor 206. Therefore a less expensive, brushed DC gear motor may be used for the second motor 206. For example, the second motor 208 may employ a planetary gearset with a reduction ratio of greater than 50:1. The direction of the second motor 208 will be reversible in some embodiments to enable both extension and retraction of the cutting line, while the first motor 206 will generally turn in a single direction. Note that AC motors may also be used for one or both of the first and second motors 206, 208, e.g., in a corded trimmer.

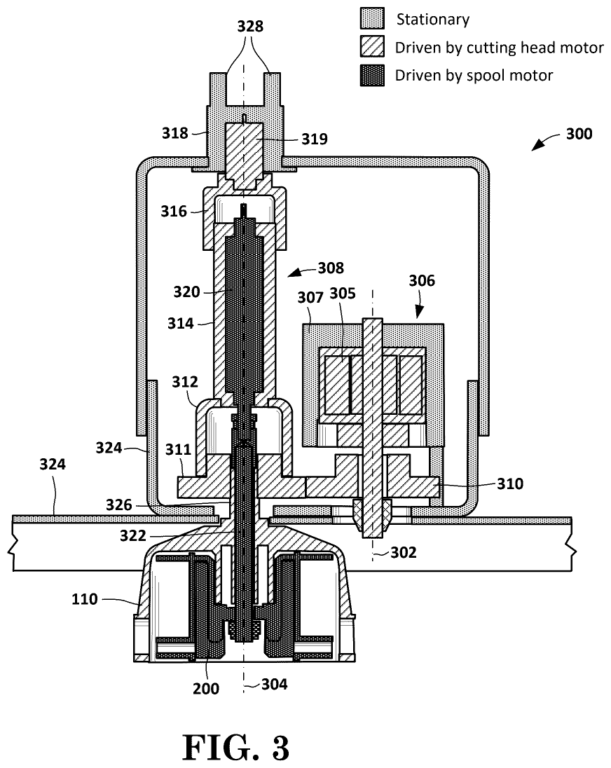

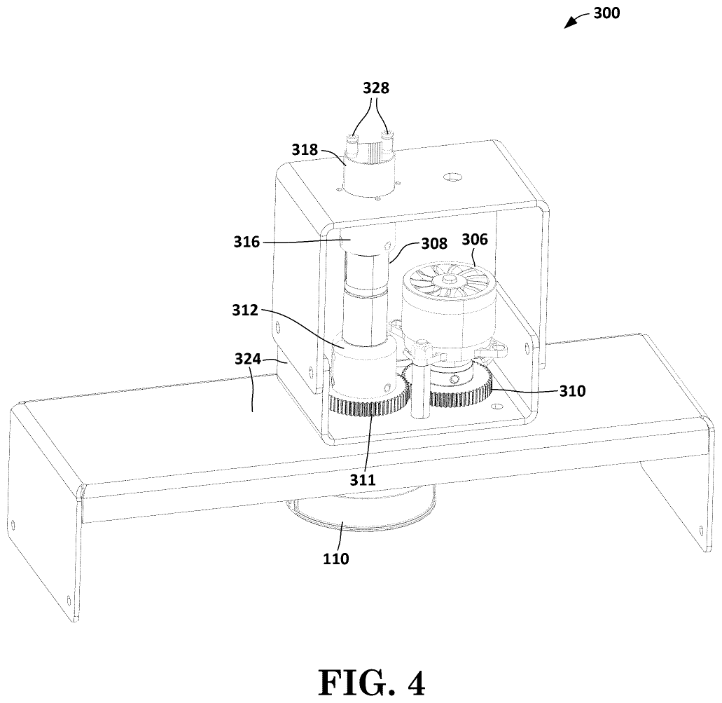

In FIGS. 3 and 4, respective cross-sectional and perspective views show a tandem motor setup for a line trimming head 300 according to an example embodiment. A rotor 305 of a first motor 306 rotates around a first rotational axis 302 while the trimming head 110, spool 200, and a second motor 308 rotates around a second rotational axis 304. The second rotational axis 304 is parallel to and offset from the first rotational axis 302. The first motor 306 drives the trimming head 110 via gears 310, 311 (e.g., spur gears). Gear 311 is coupled to the trimming head 110 at to a rotating lower housing 312 that is coupled to a stator 314 of the second motor 308. An upper rotating housing 316 is coupled to an upper end of the stator 314, and rotationally supports the second motor 308 and the trimming head via a slip ring bearing assembly 318.

A rotor 320 of the second motor 308 is coupled to a spool shaft 322, the spool shaft 322 being coupled to the spool 200. Note that while the rotor 320 is shown as a single piece, the highlighted portion may include a brushed rotor coupled to a gear train, with an output shaft extending from the gear train. The slip ring bearing assembly 318 includes a rotating part 319 with slip ring electrical connections that power the second motor 308, causing the rotor 320 to rotate relative to the stator 314 when power is applied through the slip ring terminals 328. The components highlighted with dark hatching to indicate that they are rotated by the second motor's rotor 320 and independently of the rotating housings 312, 316, trimming head 110, and stator 314, which are indicated by diagonal hatching. Note that independent rotation is meant to imply that the spool 200 and trimming head 110 can rotate at slightly different speeds, even if some of the rotational momentum for both has been imparted from the first motor 306.

The spool shaft 322 spins within an interior space of a hollow shaft 326 of the trimming head 110. A low friction sleeve or other bearing element may be disposed therebetween. Note that a test fixture 324 provides mechanical support for the components in example. In a production unit, a metal and/or plastic housing would be used for this function, e.g., housing 104 in FIG. 1. The non-rotating components, e.g., fixed structural supports, first motor stator 307, are indicated by light hatching.

The first motor 306 may be configured as a high-speed trimming head motor, e.g., operating at 3,000-6,000 RPM. The second motor 308 is a spool motor operating at a much slower speed, e.g., ˜100 RPM. Generally, the first motor 306 may rotate at a maximum first rotational speed (e.g., at or above 6,000 RPM) and the second motor 308 may rotate at a maximum second rotational speed that is 10% or less that the first rotational speed. In a typical operational mode, the trimming head 110 and spool 200 are rotated together by the first motor 306 during operation (e.g., performing trimming) while the second motor 208 is shut off (e.g., shorted, braked, or the like). When loading new cutting line onto the spool, the first motor 306 is stopped (e.g., shorted, braked, or the like) and the second motor 308 is activated to rotate the spool 200 relative to the trimming head 110.

In some embodiments, the second motor 308 can be activated during operation while the first motor 306 is spinning the trimming head 110. This can, for example, allow feeding out spool line/filament to replenish worn line, avoiding the need to manually bump the head. Moreover, activating the second motor 308 during work may also allow extending or retracting the line during operation to change the cutting diameter of the line. This can allow, for example, temporarily reducing the size of the cutting circle to allow cutting between two adjacent objects that are spaced apart a distance less than the standard/default cutting circle size.

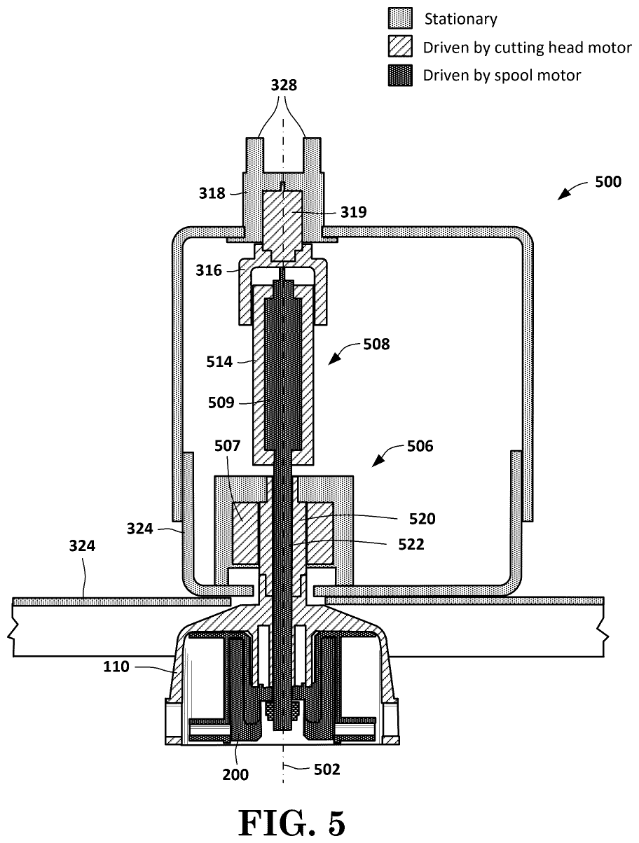

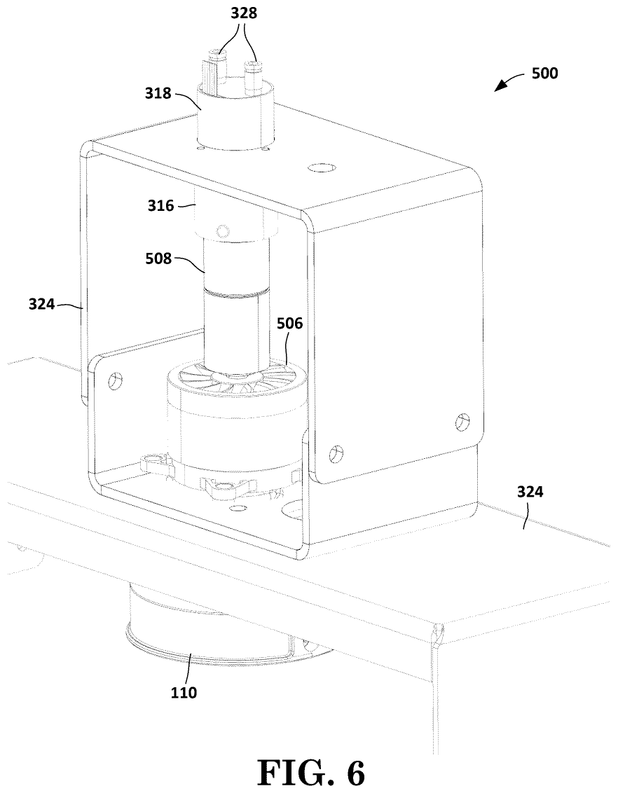

A prototype of the example shown in FIGS. 3 and 4 has been found to function as described. Other embodiments may achieve a similar functionality using a different two-motor arrangement, e.g., to occupy a smaller space within the enclosure. In FIGS. 5 and 6, respective cross-sectional and perspective views show an inline motor setup for a line trimming head 500 according to another example embodiment. For conciseness, reference numbers for some components from the previous embodiments are reused in this description, even though some changes may be evident, e.g., size of certain components or features.

A first rotor 507 of a first motor 506 and a second rotor 509 of a second motor 508 rotates around a common rotational axis 502. A spool drive shaft 522 is part of or coupled to the second rotor 509 (which may include a reduction gear train). The second rotor 509 rotates within a second stator 514. The spool drive shaft 522 is concentric to and rotates within a hollow drive shaft 520 of the first motor 506. The hollow drive shaft 520 drives the trimming head 110 and the spool drive shaft 522 rotates the spool 200 independently of the trimming head 110. The motors 506, 508 and driving gear may operate similarly to previously described embodiments, e.g., to feed cutting line in and out, change cutting circle, etc. A low friction sleeve (not shown) lines the inner surface of the hollow drive shaft 520, allowing the spool drive shaft 522 to turn differentially therein.

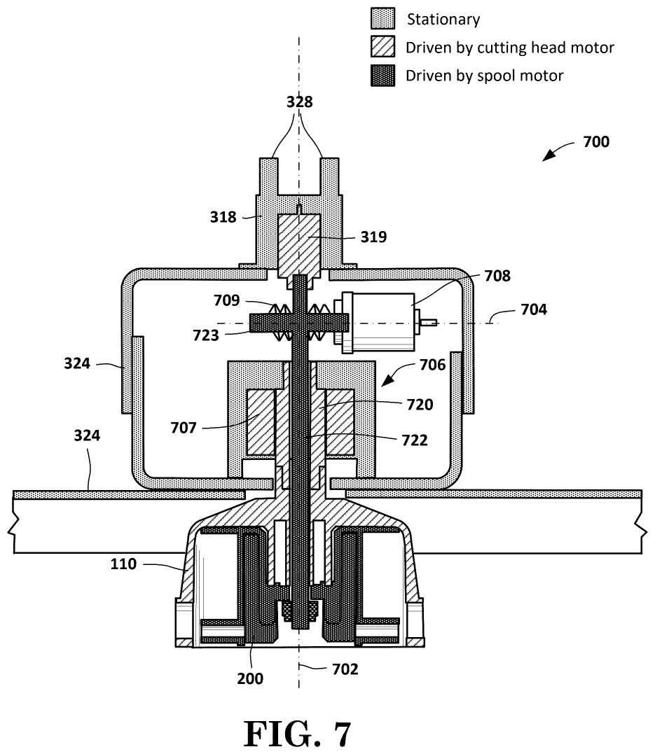

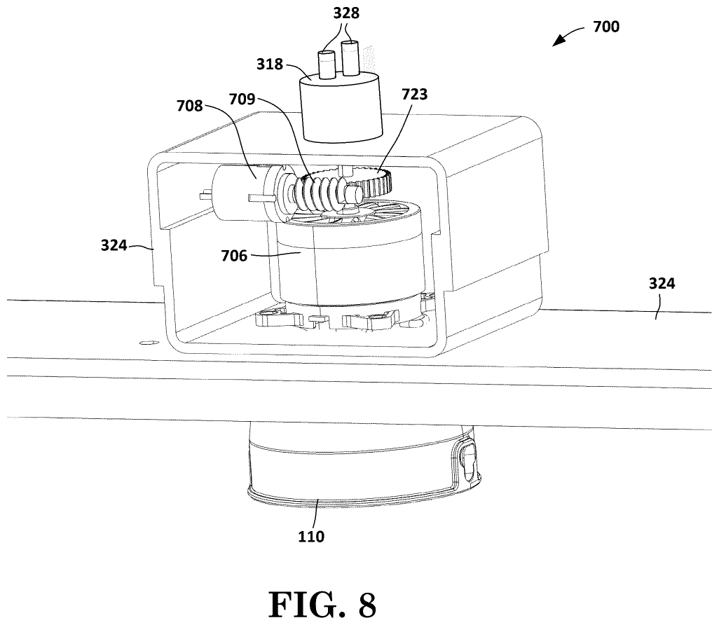

In FIGS. 7 and 8, respective cross-sectional and perspective views show a worm drive motor setup for a line trimming head 700 according to another example embodiment. For conciseness, reference numbers for some components from the previous embodiments are reused in this description, even though some changes may be evident, e.g., size of certain components or features.

A first rotor 707 of a first motor 706 rotates around a first rotational axis 702. A spool drive shaft 722 includes or is coupled to a toothed wheel 723 that is driven by a worm gear 709. The worm gear 709 is driven by a second motor 708 to rotate about a second rotational axis 704 normal to the first axis 702. The worm gear 709 and toothed wheel 723 drive the spool drive shaft 722, causing the spool drive shaft 722 to rotate within a hollow drive shaft 720 of the first motor 706. The worm gear drive will naturally brake or hold the spool drive shaft 722 when the second motor 708 is not spinning, therefore will not require electrical short circuiting or other braking means.

The hollow drive shaft 720 drives the trimming head 110 and the spool drive shaft 722 rotates the spool 200 independently of the trimming head 110. The motors 706, 708 and driving gear may operate similarly to the previously described embodiments, e.g., to feed cutting line in and out, change cutting circle, etc. A low friction sleeve (not shown) or other bearing element lines the inner surface of the hollow drive shaft 720 allowing the spool drive shaft 722 to turn differentially therein.

Note that in this example, the second motor 708 may rotate with the trimming head 110, and therefore wires (or other conductive paths) would extend from the rotating part 319 of the slip ring and be coupled to terminals on the second motor 708. Further, a rotating support (not shown) would mechanically couple the second motor 708 to the hollow drive shaft 720 or other rotating part that is driven by the first rotor 707. Such a rotating support may be weighted such that it prevents an imbalance in the trimming head 110 and associated driving parts. The rotating support may also interface with the rotating part 319 of the slip ring for support at an end of the spool drive shaft 722 facing away from the trimming head 110.

In other embodiments, the worm gear 709 could be disengaged from the toothed wheel 723 during operation of the trimmer, such that the second motor could be fixed relative to the trimming head. For example, the spool drive shaft 722 could be slidable in a first direction along the first axis 702 to simultaneously engage the spool 200 with the trimming head 110 (e.g., meshing splines on the inside of the hollow drive shaft 720 with correspond splines on the outside of the spool drive shaft 722) while disengaging the worm gear 709 from the toothed wheel 723. Sliding the spool drive shaft 722 along a second first direction opposite the first would simultaneously disengage the spool 200 from the trimming head 110 (e.g., un-meshing the splines) while engaging the worm gear 709 with the toothed wheel 723.

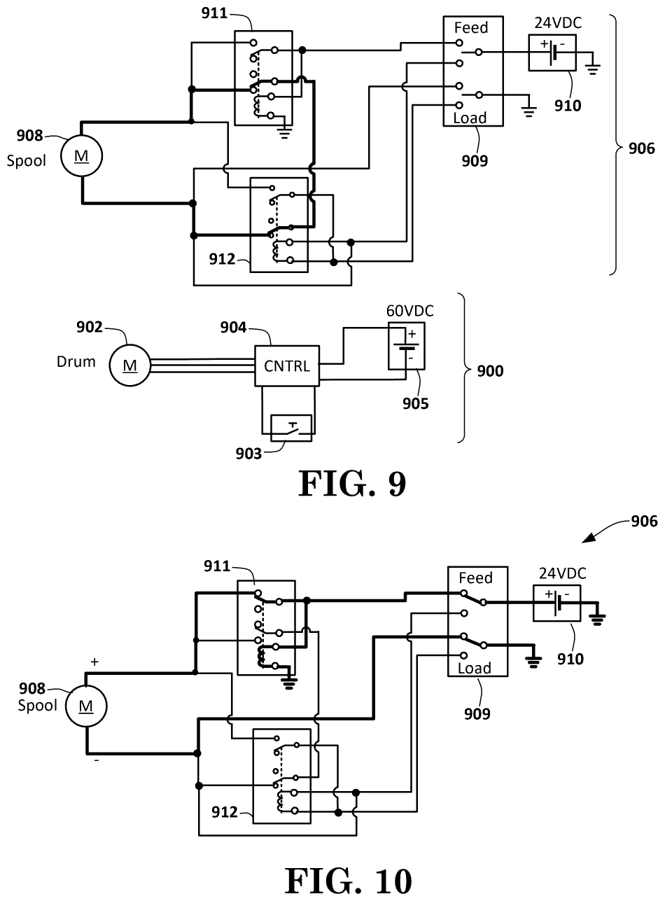

In FIG. 9, a schematic diagram shows embodiments of circuits for controlling motors of a trimmer according to example embodiments. A first circuit 900 controls a trimming head motor, designated a drum motor 902 in FIG. 9 and is designated a first motor elsewhere herein. A momentary control switch 903 turns the drum motor 902 on and off via a motor controller 904. A power supply 905 (e.g., a battery) provides power for the drum motor 902 and controller 904. The controller 904 may be programmed to ensure that the drum motor 902 turns in only one direction. In other embodiments, a stop or other mechanical device (e.g., one way bearing) may be used to limit rotation of the trimming head to a single rotational direction whether the drum motor 902 is running or not.

A second circuit 906 controls a spool motor 908, referred to as a second motor elsewhere herein. A two-position momentary switch 909 is coupled to a power supply 910. Note that the power supply 910 may receive power from the power supply 905, e.g., via a DC-DC converter. Further, the voltages shown for these power supplies 905, 910 may be different from what is shown. First and second relays 911, 912 are coupled to the momentary switch 909, and operate as described below.

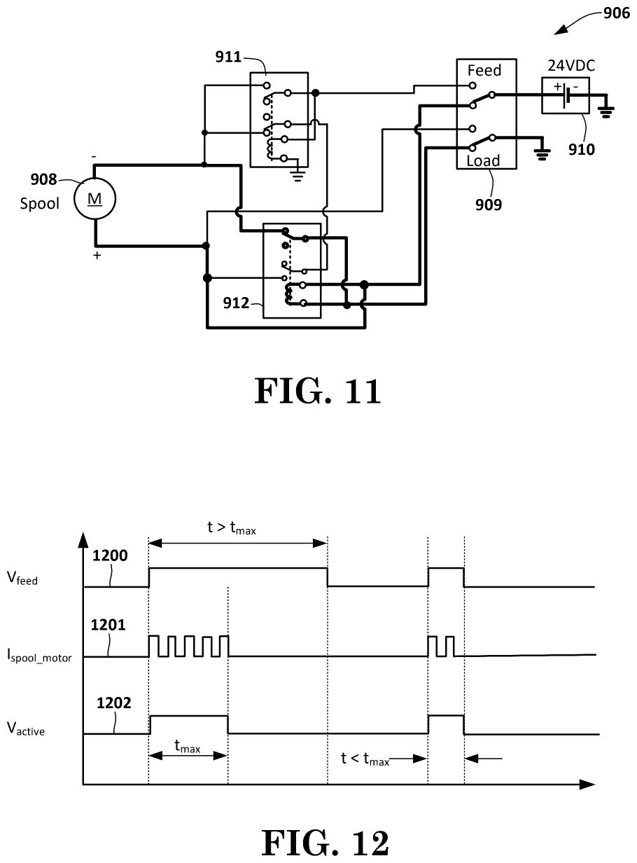

The momentary switch 909 has three positions: deactivated (as shown in FIG. 9), feed (as shown in FIG. 10), and load (as shown in FIG. 11). In this example, the first and second circuits 900, 906 are independent, such that motors 902, 908 could be run at the same time. In other embodiments, additional circuitry could be used to change this, e.g., to prevent activating spool motor 908 in one or both directions when drum motor 902 is operating. In FIGS. 10 and 11, only the second circuit 906 is shown to illustrate the operation when the momentary switch 909 is in the respective feed and load positions

In FIG. 9, the momentary switch 909 is in the deactivated, center position. Deactivation of the switch 909 results in first and second relays 911, 912 being deactivated, causing the spool motor 908 to be shorted out as indicated by the bold lines in FIG. 9. Shorting of the motor 908 will brake the motor, helping to prevent shifting between the spool and trimming head when the trimming head accelerates and decelerates.

In FIG. 10, the second circuit 906 is shown with momentary switch 909 in the feed position. The bold lines in FIG. 10 represent current flow, which activates the first relay 911 and spool motor 908 in a first direction, indicated by the polarity of voltage applied to the motor 908. The operation of the spool motor 908 will cause the trimming line to be fed out from the trimming head, e.g., to replenish a worn cutting line. In order to prevent excessive feed rates, the spool motor 908 may be pulsed via the first relay 911.

To provide pulsing, the first relay 911 may be configured as a timed relay that provides a pulsed output as shown in the graph of FIG. 12. In FIG. 12, the top trace 1200 represents a voltage applied from the momentary switch 909 in the feed position. The middle trace 1201 represents a current flowing through the spool motor 908 via the first relay 911. When the middle trace is at zero, the contacts of the first relay 911 are in the deactivated position as shown in FIG. 9, which will short out and brake the spool motor 908. The bottom trace 1202 represents an internal state of the first relay 911 which enables pulsing of the relay. This internal state can be programmed to limit a maximum time of the pulsing to tₘₐₓ as shown in the first set of traces on the left of the figure. The right side of the graph shows the relay behavior if the momentary switch voltage is applied for less than tₘₐₓ.

In FIG. 11, the second circuit 906 is shown with momentary switch 909 in the load position. The bold lines in FIG. 11 represent current flow, which activates the second relay 912 and spool motor 908 in a second direction opposite the first, indicated by the polarity of voltage applied to the motor 908. The second relay is not pulsed, thus the spool motor 908 will run continuously with the switch 909 in this position, allowing the spool to quickly draw in new trimming line to reload the spool.

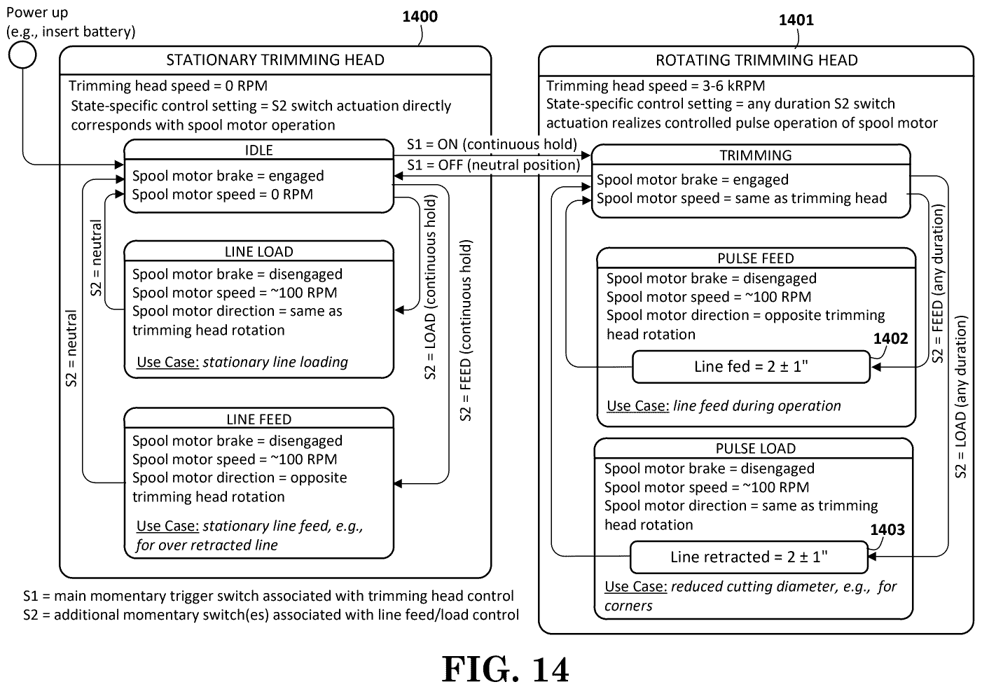

Note that while a double pole momentary switch 909 is shown activating both feed and load operations in FIGS. 9-11, separate switches may be used. For example, it may be more convenient to have a feed and/or load switch located at the handle 102 as this is where the operator's hands will be during operation. This switch will allow for operational mode functions such as changing cutting circle and replenishing the trimming line. In contrast, when loading the spool, the operator may be grasping the trimmer near the housing 104 in order to guide new line into the trimming head, and thus the load switch may be located near the housing 104. In such a case, two switches may be used in place of the double-pole, double-throw switch shown in FIGS. 9-11, with additional circuit elements to protect against both switches being activated at once. This may be accomplished, for example, by routing the coil activation current path for one of the relays 911, 912 through the deactivated contacts of the other of the relays 911, 912, such that both relays cannot be activated at once. In this embodiment, one of the relays 911, 912 could have a third pole in series with the other of the relays. In other embodiments (see description of FIG. 14 below), the above-described functionality of the spool control circuit may be implemented in a custom logic circuit (e.g., field programmable gate array), a microcontroller (e.g., programmed into firmware), integrated with the drum motor controller 904, etc.

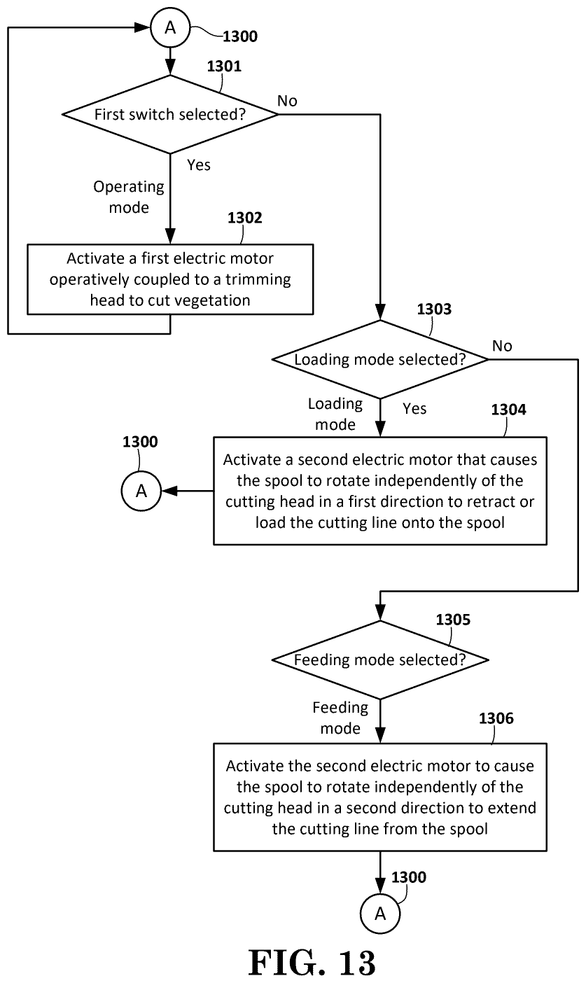

In FIG. 13, a flowchart illustrates a method according to an example embodiment. The method operates in a continuous loop, as indicated by on-page reference blocks 1300. The method involves checking 1301 if a first switch is selected which triggers or initiates an operating mode. In the operating mode, a first electric motor is activated 1302. The first motor is operatively coupled to a trimming head. A spool is contained within and selectively connected to the trimming head such that the trimming head and spool rotate together when the trimmer in the operating mode to cut vegetation via a cutting line that extends from the trimming head. The spool is configured to receive a length of the cutting line, which may be loaded in a cutting mode.

At block 1303, a loading mode is selected, e.g., via one or more second switches. In the loading mode, the second switch or switches activate 1304 a second electric motor different from the first motor. The second motor causes the spool to rotate independently of the trimming head in a first direction to retract or load the cutting line onto the spool. At block 1305, a feeding mode is selected, e.g., via the same switch used in the selection of block 1303 or a different switch. In the feeding mode, the second motor is activated 1306 to cause the spool to rotate independently of the trimming head in a second direction to extend the cutting line from the spool.

Note that in FIG. 13, the loading or feeding mode is only actuated if the first switch is not in operating mode. As described elsewhere herein, the second electric motor may also be activated at the same time the first motor is actuated for in-use extension and/or retraction of the cutting line. In FIG. 14, a state diagram illustrates how the first motor (e.g., trimming head motor or drum motor) and second motor (e.g., spool motor) may operate either singly or together in various states. The states and transitions therebetween in block 1400 and 1401 correspond respectively to conditions where the trimming head is stationary or rotating. Note that blocks 1402, 1403 represent timer states where the line is fed or retracted using a pulse signal for a limited amount of time, here expressed as a length of line that can be extended or retracted in that time.

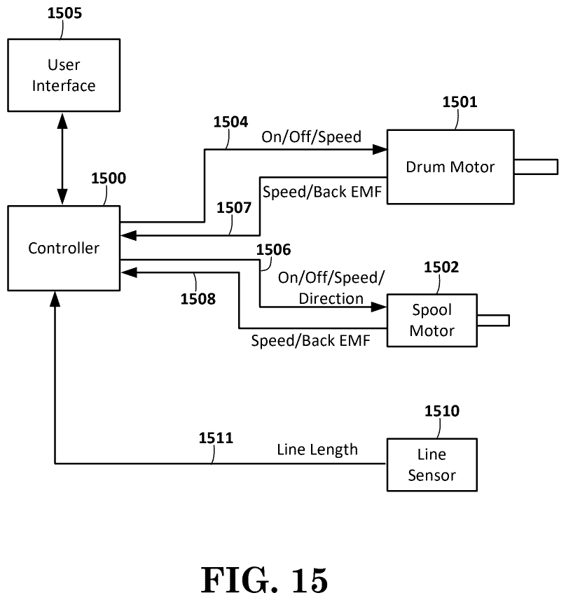

As noted above, a programmable controller could be used to implement the functionality shown in FIGS. 9-14. In FIG. 15, a block diagram illustrates an arrangement that can provide previously described and additional line control features according to various embodiments. A controller 1500 can be configured to provide power control of first and second motors 1501, 1502, which are labeled as drum and spool motors in the figure. For example, the controller 1500 outputs or controls power 1504 operable to turn the first motor 1501 on and off, and also to affect speed, e.g., in response to a variable signal from a user interface 1505. The user interface 1505 includes a control such as a trigger switch that controls the first motor 1501. The trigger switch or the like may provide multiple outputs to control speed, e.g., via a variable resistor.

In addition, the controller 1500 outputs or controls power 1506 operable to turn the first motor 1501 on and off, and also to affect speed (e.g., via pulse width modulation) and direction. The user interface 1505 will have a different control for the second motor 1502, e.g., at least one second switch different from the first switch (e.g., trigger switch) that controls the first motor 1501. The controls for the second motor 1502 may include multiple switches, e.g. one located on or near a handle for changing the cutting circle and one on or near the motor enclosure for feeding line onto the spool.

The motors 1501, 1502 may also provide sensor data 1507, 1508 back to the controller with data indicative of motor operation, such as speed and back electromagnetic force (BEMF). This data 1507, 1508 may be used as feedback for closed loop control of various operational aspects of the trimmer. For example, BEMF of the first motor 1501 while operating at steady state may be indicative of how much cutting line has been extended from the trimming head, and so may be used to meter or stop extension or retraction of the line via the second motor 1502 when some threshold has been reached.

More precise measurement and control of the cutting line may be provided by one or more line sensors 1510 which provide a signal 1511 indicative of line length. The signal 1511 may provide a discrete value indicating one or more lengths, e.g., an impact sensor that detects the line hitting the shroud, indicating a maximum extension length. In other embodiments, two or more discrete values may be measured, e.g., allowing the cutting circle to be set between two presents, such as 12″ and 16″. This type of control may be achieved via a continuous sensor, such as a proximity sensor, optical sensor, audio sensor, etc., that can derive a continuous range of values indicative of an amount of cutting line that is currently extended from the trimming head. These measurements will be typically made with the first motor 1501 running, such that centrifugal force stretches the cutting line out to its full extended length.

The line length measurements as described above may be used in a number of ways. For example, the cutting line may be automatically extended during use to compensate for worn and broken ends of the cutting line. The cutting circle may be automatically adjusted between two or more different values based on a discrete switch selection at the user interface 1505. These measurements may also be useful when responding to manual inputs for similar actions. For example, if the operator has held down a feed switch too long such that excessive line is playing out, the second motor 1502 could be halted. Also, the user interface 1505 may include an output device (e.g., a row of light emitting diodes) that indicate line length so that the operator can exercise more fine control over cutting line extension and retraction.

In view of the above, it will be readily apparent that the functionality of the controllers of the system may be implemented in any manner known to one skilled in the art. For instance, the memory may include any volatile, non-volatile, magnetic, optical, and/or electrical media, such as a random-access memory (RAM), read-only memory (ROM), non-volatile RAM (NVRAM), electrically-erasable programmable ROM (EEPROM), flash memory, and/or any other digital media.

The processors used in the controllers may include any one or more of a microprocessor, a controller, a digital signal processor (DSP), an application specific integrated circuit (ASIC), a field-programmable gate array (FPGA), and/or equivalent discrete or integrated logic circuitry. In some embodiments, the processor may include multiple components, such as any combination of one or more microprocessors, one or more controllers, one or more DSPs, one or more ASICs, and/or one or more FPGAs, as well as other discrete or integrated logic circuitry. The functions attributed to the controller and/or processor herein may be embodied as software, firmware, hardware, or any combination of these. Certain functionality of the controller may also be performed in the cloud or other distributed computing systems operably connected to the processor.

While the present disclosure is not so limited, an appreciation of various aspects of the disclosure will be gained through a discussion of the specific illustrative aspects provided below. Various modifications of the illustrative aspects, as well as additional aspects of the disclosure, will become apparent herein.

Example 1 is a line trimmer comprising: a trimming head associated with a housing; a spool contained within the trimming head, wherein the spool is selectively connected to the trimming head such that the trimming head and the spool rotate together when the line trimmer is in an operating mode, the spool configured to receive a length of cutting line such that one or more ends of the cutting line extend from the head and cut vegetation as the trimming head rotates; a first electric motor contained within the housing and operatively coupled to the trimming head, wherein the first electric motor is configured to rotate the trimming head, along with the spool, when the trimmer is in the operating mode; and a second electric motor contained within the housing and operatively coupled to the spool, the second electric motor configured to rotate the spool independently from the trimming head.

Example 2 includes the line trimmer of example 1, wherein actuation of the second electric motor without actuation of the first electric motor permits powered winding of the cutting line onto the spool. Example 3 includes the line trimmer of example 1 or 2, wherein actuation of the second electric motor during actuation of the first electric motor is configured to change a cutting diameter of the cutting line.

Example 4 includes the line trimmer of any one of examples 1-3, wherein the first electric motor comprises a first output shaft and the second electric motor comprises a second output shaft concentric to the first output shaft. Example 5 includes the line trimmer of any one of examples 1-3, wherein the first electric motor comprises a first output shaft that rotates around a first rotational axis and the second electric motor comprises a second output shaft that rotates around a second rotational axis different from the first rotational axis. Example 6 includes the line trimmer of example 5, wherein the first and second axes are parallel to each other. Example 7 includes the line trimmer of example 6, wherein the first output shaft is coupled to the trimming head via gears, and wherein the second output shaft is directly coupled to the spool. Example 8 includes the line trimmer of example 5, wherein the first and second axes are normal to each other. Example 9 includes the line trimmer of example 8, wherein the first electric motor comprises a hollow output shaft in having a distal portion connected to the trimming head, the line trimmer further comprising a spool drive shaft disposed and independently rotating within the hollow output shaft and having a distal end connected to the spool, wherein the second output shaft is coupled to the spool drive shaft via a worm gear.

Example 10 includes the line trimmer of any one of examples 1-9, wherein the first electric motor comprises a hollow output shaft having a distal portion connected to the trimming head. Example 11 includes the line trimmer of example 10, wherein the second electric motor is comprises or is coupled to a spool drive shaft received within an interior space of the hollow output shaft of the first electric motor.

Example 12 includes the line trimmer of any one of examples 1-11, wherein the first motor rotates at a maximum first rotational speed and the second motor rotates at a maximum second rotational speed that is 10% or less that the first rotational speed. Example 13 includes the line trimmer of any one of examples 1-11, further comprising a switch configured to actuate the second electric motor. Example 14 includes the line trimmer of example 13, further comprising a handle and a shaft connecting the handle to the housing, wherein the switch is located on the handle. Example 15 includes the line trimmer of example 13, wherein the switch is located on or near the housing. Example 16 includes the line trimmer of example 13, wherein a rotational direction of the second electric motor is selectable via the switch to operate between: a first direction configured to extend the cutting line out of the trimming head; and a second direction configured to retract the cutting line into the trimming head. Example 17 includes the line trimmer of example 16, wherein the second electric motor is coupled to the switch via a circuit configured to pulse the second electric motor when selected to run in the first direction. Example 18 includes the line trimmer of any one of examples 1-18, further comprising a stop to limit rotation of the trimming head to a single rotational direction.

Example 19 is a method of operating a line trimmer comprising: selecting an operating mode via a first switch to activate a first electric motor operatively coupled to a trimming head, wherein a spool is contained within and selectively connected to the trimming head such that the trimming head and the spool rotate together when the line trimmer in the operating mode to cut vegetation via a cutting line that extends from the trimming head, wherein the spool is configured to receive a length of the cutting line; and selecting a loading mode via one or more second switches that activate a second electric motor different from the first motor that causes the spool to rotate independently of the trimming head in a first direction to retract or load the cutting line onto the spool. Example 20 includes the method of example 19, further comprising selecting a feeding mode via the one or more second switches that activate the second electric motor that causes the spool to rotate independently of the trimming head in a second direction to extend the cutting line from the spool.

Example 21 includes the method of example 20, wherein the one or more second switches comprises a feed switch operable to select the feeding mode. Example 22 includes the method of example 21, wherein the one or more second switches comprises a load switch separate from the feed switch and operable to select the loading mode. Example 23 includes the method of example 22, wherein the feed switch is located proximate a housing that houses the trimming head, and wherein in the load switch is proximate the first switch on or near a handle of the line trimmer.

Example 24 includes the method of any one of examples 20-23, wherein activating the second electric motor to rotate the trimming head in the second direction comprises pulsing the second electric motor. Example 25 includes the method of any one of examples 20-24, wherein the loading mode and the feeding mode are selectable during the operating mode to change a cutting circle of the line trimmer.

Example 26 is method of operating a line trimmer comprising: selecting an operating mode via a first switch to activate a first electric motor operatively coupled to a trimming head, wherein a spool is contained within and selectively connected to the trimming head such that the trimming head and the spool rotate together when the trimmer in the operating mode to cut vegetation via a cutting line that extends from the trimming head, wherein the spool is configured to receive a length of the cutting line; and selecting a feeding mode via one or more second switches that activate a second electric motor different from the first motor that causes the spool to rotate independently of the trimming head in a second direction to extend the cutting line from the spool.

Example 27 includes the method of example 26, wherein the feeding mode is selectable during the operating mode to change a cutting circle of the line trimmer or to replenish worn cutting line. Example 28 includes the method of example 26 or 27, wherein activating the second electric motor to rotate the trimming head in the second direction comprises pulsing the second electric motor.

It is noted that the terms “have,” “include,” “comprises,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the machine is in an operating configuration. These terms are used only to simplify the description, however, and not to limit the interpretation of any embodiment described. As used herein, the terms “determine” and “estimate” may be used interchangeably depending on the particular context of their use, for example, to determine or estimate a position or pose of a vehicle, boundary, obstacle, etc.

Further, it is understood that the description of any particular element as being connected to or coupled to another element can be directly connected or coupled, or indirectly coupled/connected via intervening elements.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

The various embodiments described above may be implemented using circuitry, firmware, and/or software modules that interact to provide particular results. One of skill in the arts can readily implement such described functionality, either at a modular level or as a whole, using knowledge generally known in the art. For example, the flowcharts and control diagrams illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to provide the functions described hereinabove.

Note that any components described herein using terms such as “processor,” “controller,” “logic circuit,” “CPU,” or the like may be implemented using a plurality of discrete units operating together. For example, a processer that performs a series of steps or operations may be construed as two or more processors operating cooperatively to perform the steps. Similarly, other processing hardware such as memory and input-output may perform the described functions with multiple discrete units operating cooperatively or being coordinated by another unit, e.g., by a central processor or processors.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination and are not meant to be limiting, but purely illustrative. It is intended that the scope of the invention be limited not with this detailed description, but rather determined by the claims appended hereto.

1. A line trimmer comprising:
a trimming head associated with a housing;
a spool contained within the trimming head, wherein the spool is selectively connected to the trimming head, the spool configured to receive a length of cutting line such that one or more ends of the cutting line extend from the head and cut vegetation as the trimming head rotates;
a first electric motor contained within the housing and operatively coupled to the trimming head, wherein the first electric motor is configured to rotate the trimming head, along with the spool, when the trimmer is in an operating mode; and
a second electric motor contained within the housing and operatively coupled to the spool, the second electric motor configured to rotate the spool independently from the trimming head.

2. The line trimmer of claim 1, wherein actuation of the second electric motor without actuation of the first electric motor permits powered winding of the cutting line onto the spool.

3. The line trimmer of claim 1, wherein actuation of the second electric motor during actuation of the first electric motor is configured to change a cutting diameter of the cutting line.

4. The line trimmer of claim 1, wherein the first electric motor comprises a first output shaft and the second electric motor comprises a second output shaft concentric to the first output shaft.

5. The line trimmer of claim 1, wherein the first electric motor comprises a first output shaft that rotates around a first rotational axis and the second electric motor comprises a second output shaft that rotates around a second rotational axis different from and parallel to the first rotational axis.

6. The line trimmer of claim 5, wherein the first output shaft is coupled to the trimming head via gears, and wherein the second output shaft is directly coupled to the spool.

7. The line trimmer of claim 1, wherein the first electric motor comprises a first output shaft that rotates around a first rotational axis and the second electric motor comprises a second output shaft that rotates around a second rotational axis different from and normal to the first rotational axis.

8. The line trimmer of claim 7, wherein the first electric motor comprises a hollow output shaft in having a distal portion connected to the trimming head, the line trimmer further comprising a spool drive shaft disposed and independently rotating within the hollow output shaft and having a distal end connected to the spool, wherein the second output shaft is coupled to the spool drive shaft via a worm gear.

9. The line trimmer of claim 1, wherein the first electric motor comprises a hollow output shaft having a distal portion connected to the trimming head.

10. The line trimmer of claim 9, wherein the second electric motor comprises or is coupled to a spool drive shaft received within an interior space of the hollow output shaft of the first electric motor.

11. The line trimmer of claim 1, wherein the first motor rotates at a maximum first rotational speed and the second motor rotates at a maximum second rotational speed that is 10% or less that the first rotational speed.

12. The line trimmer of claim 1, further comprising a switch configured to actuate the second electric motor, and wherein a rotational direction of the second electric motor is selectable via the switch to operate between:
a first direction configured to extend the cutting line out of the trimming head; and
a second direction configured to retract the cutting line into the trimming head.

13. The line trimmer of claim 12, wherein the second electric motor is coupled to the switch via a circuit configured to pulse the second electric motor when selected to run in the first direction.

14. The line trimmer of claim 1, further comprising a stop to limit rotation of the trimming head to a single rotational direction.

15. A method of operating a line trimmer comprising:
selecting an operating mode via a first switch to activate a first electric motor in an operating mode, the first electric motor being operatively coupled to a trimming head, wherein a spool is contained within and selectively connected to the trimming head, the first electric motor rotating the trimming head and the spool in the operating mode to cut vegetation via a cutting line that extends from the trimming head, wherein the spool is configured to receive a length of the cutting line; and
selecting one or more second switches to activate a second electric motor different from the first motor that causes the spool to rotate independently of the trimming head to: retract or load the cutting line onto the spool; or feed the cutting line from the spool.

16. The method of claim 15, wherein the one or more second switches comprises:
a feed switch operable to feed the cutting line from the spool; and
a load switch separate from the feed switch and operable to retract or load the cutting line onto the spool.

17. The method of claim 16, wherein the second electric motor is activated during the operating mode to change a cutting circle of the line trimmer.

18. The method of claim 17, wherein activating the second electric motor to rotate the trimming head comprises pulsing the second electric motor.

19. A method of operating a line trimmer comprising:
selecting an operating mode via a first switch to activate a first electric motor operatively coupled to a trimming head, wherein a spool is contained within and selectively connected to the trimming head such that the trimming head and the spool rotate when the trimmer in the operating mode to cut vegetation via a cutting line that extends from the trimming head, wherein the spool is configured to receive a length of the cutting line; and
selecting a feeding mode via one or more second switches that activate a second electric motor different from the first motor that causes the spool to rotate independently of the trimming head to extend the cutting line from the spool.

20. The method of claim 19, wherein the feeding mode is selectable during the operating mode to change a cutting circle of the line trimmer or to replenish worn cutting line.

21. The method of claim 19, wherein activating the second electric motor comprises pulsing the second electric motor.
